(19) United States
(12) Patent Application Publication
(10) Pub. No.: US 2023/0348733 A1
(43) Pub. Date: Nov. 2, 2023

(54) CORROSION-RESISTANT COATINGS

(71) Applicant: Coatings for Industry, Inc., Souderton, PA (US)

(72) Inventors: Bruce G. McMordie, Perkasie, PA (US); Brian Klotz, Perkasie, PA (US)

(73) Assignee: Coatings for Industry, Inc., Souderton, PA (US)

(21) Appl. No.: 18/043,529

(22) PCT Filed: Aug. 26, 2021
(86) PCT No.: PCT/US21/47696

§ 371 Date: Feb. 28, 2023

Related U.S. Application Data
(60) Provisional application No. 63/214,365, filed on Jun. 24, 2021.
(60) Provisional application No. 63/113,508, filed on Nov. 13, 2020.
(60) Provisional application No. 63/071,526, filed on Aug. 28, 2020.

(51) Int. Cl. C09D 5/08; C09D 5/00; C09D 5/24; C09D 1/04; C09D 127/18; C09D 183/04

(52) U.S. Cl. CPC C09D 5/084; C09D 5/002; C09D 5/24; C09D 1/04; C09D 127/18; C09D 183/04

(57) ABSTRACT

A process for forming on a corrodible substrate a corrosion-resistant multi-ply coating comprising: (a) applying an aluminum-containing silicate slurry onto the surface of the substrate and heating the deposited slurry to form a cured composite of an aluminum-Containing silicate basecoat that is not electrically conductive, optionally repeating the aforementioned step to form a thicker multi-ply coating, (b) applying an initial solution of tri valent aluminum and phosphate ions (Al⁺³PO₄) to the surface of said basecoat and heating the substrate that has thereon said solution to form a cured ply comprising a composite that is not electrically conductive; (c) mechanically working the surface of the composite to form a modified composite which is in electrically conductive form; and (d) applying to the surface of the modified composite an additional solution of divalent aluminum and phosphate ions (Al⁺³PO₄), the composition of which may be the same as or different from said initial solution, and heating the modified conductive coated surface having thereon said additional solution under conditions which cure it to form said multi-ply coating which is not electrically conductive, a multi-ply coating prepared by the process, and an article coated with the multi-ply coating.

### CROSS REFERENCE

This application claims the benefit of the filing dates of the following Parent applications: Application No. 63/214,365, filed Jun. 24, 2021; Application No. 63/113,508, filed Nov. 13, 2020; and Application No. 63/071,526, filed Aug. 28, 2020. This application and the Parent applications disclose the formation on a metallic surface of a multi-ply corrosion-resistant coating.

### FIELD OF THE INVENTION

The present invention relates to an environmentally acceptable process for forming corrosion-resistant coatings on substrates which have a tendency to be degraded when subjected to various environmental conditions, for example, water which can rust vulnerable metals. The invention relates also to multi-ply coatings which are prepared by the aforementioned process and, in addition, to articles which comprise such coatings.

Examples of such articles are industrial gas turbines that comprise steel components and that operate with inlet fogging or wet compression to increase power. The use of inlet fogging injects fine water droplets into the air as it enters the turbine. Evaporation of the droplets cools the air; this increases the mass flow through the turbine and results in boosting the power output. However, water often accumulates in the compressor sections of turbines during fogging. When that happens, coated parts are not only exposed to water vapor but also wind up in condensed water having a temperature near its boiling point. Unless properly coated, turbine parts do not survive such conditions.

As will be appreciated from the following description of the present invention, it can be used also in other coating applications, for example, in various applications that rely on the use of coating compositions that comprise non-environmentally acceptable hexavalent chromium, and in other types of rotating machinery and applications where metallic or ceramic materials are exposed to various types of corrosive materials which include both liquids and gaseous materials.

### SUMMARY OF THE INVENTION

The present invention provides a coating process which is effective for forming a multi-ply, sacrificial, corrosion-resistant coating system that incorporates the use of compositions that are free of hexavalent chromium ions. One embodiment of this invention comprises a process that includes the following steps.
(A) Applying an aluminum-containing silicate slurry onto a metallic or “other vulnerable” surface and then
(B) Heating the deposited slurry to form a cured composite of an aluminum-containing silicate basecoat that is not electrically conductive (Steps (A) and (B) may be repeated to build a plurality of thicker multi-ply coatings).
(C) Applying an initial solution of trivalent aluminum and phosphate ions (Al⁺³PO₄) to the surface of the basecoat so that it is absorbed therein and then
(D) Heating the aluminum-silicate ply that is now saturated with the phosphate solution of Step (C) to form a cured ply comprising a modified composite that is not electrically conductive.
(E) Mechanically working the surface of the modified composite to convert it to an electrically conductive form, for example, lowering its resistance to less than about 15 ohms.
(F) Applying an additional solution of trivalent aluminum and phosphate ions (Al⁺³PO₄), the composition of which may be the same as or different from that used in Step (C), to the mechanically worked conductive surface and then.
(G) Heating the conductive coated surface under conditions which cure it to form a ply of the coating which is not electrically conductive.

The present invention provides also an article coated with a protective multi-ply coating that is free of hexavalent chromium and that is formed from aforementioned Steps (A) to (G) and also applications in which the articles are used.

Another embodiment of this invention comprises applying to an aluminum-containing silicate basecoat of the type set forth in steps (A) and (B) above the solutions of trivalent aluminum phosphates as set forth in each of the solutions of (C) and (D) and of (F) and (G) and including the “mechanically working” step of (E) prior to applying the solution of (F) and (G).

There are numerous advantages that are associated with the practice of the present invention. Toxic chromium-based coating compositions have been considered for many years as the standard in industry for forming coatings which are highly corrosion-resistant. The present invention enables one to form such highly corrosion-resistant coatings, but without the need for use of environmentally detrimental constituents, for example, hexavalent chromium. Another advantage of the composition of the present invention is that the silicate-based composition is a “one-part” composition in that all of the constituents can be mixed together into a single formulation well prior to use and without one or more of the constituents affecting adversely the other constituents of the composition. Non-chromium-based compositions of the prior art are typically “two-part” compositions which need to be mixed together just prior to use. The treatment of prior art aluminum-containing silicate compositions with the aluminum ion/phosphate fortifier according to the present invention further improves the hot water- and corrosion-resistant properties and other important properties of prior art coatings that are considered to have less than satisfactory stability in hot water and water vapor and/or corrosion-resistance. The description below refers to specific improvements associated with the practice of the present invention.

### DETAILED DESCRIPTION OF THE INVENTION

As used herein:

The terms “conductive” and “non-conductive” mean respectively—electronically conductive—and—electronically non-conductive—.

The term “conductive” means that when two ohmmeter probes are lightly placed one-inch apart on the surface of a ply of the coating so as not to penetrate the surface of the ply, the electrical resistance measured between those probes is no greater than about 20 ohms, preferably no greater than about 15 ohms, and more preferably less than about 10 ohms.

The term hexavalent chromium (Cr⁺⁶) refers to a material which is toxic and considered environmentally unacceptable. The term Cr⁺⁶Free means a composition that contains less than one part per million (<1 ppm) of hexavalent chromium. The term does not refer to trivalent chromium which is considered presently to be not toxic. The term Cr-Free means a composition which contains no chromium compound of any kind.

Unless indicated otherwise, “%” means weight percent based on the total weight of the involved composition.

### Formation of the Al Silicate Non-Conductive Basecoat

The formation of the aluminum-containing silicate non-conductive basecoat referred to in Steps (A) and (B) above is made from an aqueous composition that has dispersed therein solid aluminum particles and alkali metal silicate(s), for example, sodium, lithium, and potassium (hereafter referred to also as an “aluminum-silicate slurry”); such slurries are described in U.S. Pat. Nos. 9,739,169 and 9,017,464.

Prior to applying the slurry to the surface to be coated, it should be cleaned and preferably roughened by grit-blasting. Also, any residual grit and dust should be removed before the slurry is applied.

The aluminum-silicate slurry can be applied to the surface according to available techniques, for example, sprayed onto the prepared surface using an air-atomizing spray gun. Alternatively, the slurry may be applied by dipping or with a brush, roller, or foam pad. Preferably, there is applied a uniform coating of slurry that is not so thick that it cracks upon drying.

In Step (B) of the present invention, the aluminum-silicate slurry applied in Step (A) is dried in air and then heated or baked to a “cured” aluminum silicate ply in which the now solid silicate binds aluminum particles to one another and the substrate. The term “cured” means that the water has been irreversibly removed from the aluminum-silicate slurry to form a solid aluminum-silicate ply that is not conductive.

In preferred form, parts coated with aluminum-silicate slurry in Step (A) are first dried in air until all appearance of wetness is gone from the coated surfaces, then heated at roughly 1759F (79° C.) until the core of the part has been at that temperature for at least 15 minutes before being finally heated at 650° F. (343° C.) until the part (and the ply of coating) have been at that temperature for at least 30 minutes. It is known to one skilled in the art that temperatures and times used to cure the aluminum-silicate slurry may vary.

Pursuant to the use of Steps (A) and (B), the solid, insoluble aluminum-silicate layer forms the base or foundation of the multi-ply coating, also referred to hereafter for convenience as the “basecoat”.

As disclosed by Klotz (U.S. Pat. No. 9,017,464) and by Belov (U.S. Pat. No. 9,739,169), prolonged heating of the basecoat near or above 1000° F. (538° C.) transforms the cured non-conductive layer into one that is electrically conductive, that is, one with an electrical resistance that measures less than about 15 ohms. The heat treatment used for Step (B) of the present invention is such that bound and unbound water is removed from the dried layer of the aqueous silicate, but such that the cured coating is not converted to a conductive coating.

As stated briefly above, Steps (A) and (B) may be repeated to form a thicker basecoat by applying a plurality of cured coats of aluminum-silicate over the first coat. It is also within the scope of this invention to apply a wet coat of aluminum-silicate slurry according to Step (A) and allow it to thoroughly dry and then apply a second coat of wet slurry (Step (A) again) before drying and curing the aluminum-silicate slurry in Step (B).

In a particularly preferred form, the aluminum-silicate slurry that is applied to the metallic surface comprises an aqueous solution of sodium silicate and lithium silicate and the solution in an even more preferred form includes polysilicate. Aluminum powder is dispersed in the solution. The resulting aluminum-silicate slurry is then applied to the metallic surface in preferred form

Application of Initial Al⁺³PO₄ Solution

Following the formation of the basecoat, there is applied to the surface thereof an initial coating solution comprising trivalent aluminum and phosphate ions which is absorbed by the basecoat.

As described hereafter, the coating formed from the Al⁺³PO₄ solution comprises a ply of the multi-ply coating which is bonded to the surface of the basecoat and which in its cured form is non-conductive. It is believed that this ply of the multi-ply coating of the present invention functions to contribute to improving the properties of the final coating to resist blistering when exposed to hot water and/or water vapor.

Various water soluble compounds which contain trivalent aluminum can be used, for example, aluminum oxide. A preferred source of the aluminum ion is aluminum trihydrate. Various water soluble compounds which contain phosphate can be used as the sources of the phosphate ions. Although phosphoric acid is the preferred source of phosphate ions, there can be used also other water soluble phosphate compounds. The Al⁺³PO₄ solution can comprise a composition in which all of the ingredients are in solubilized form or a composition comprising a dispersion in which some of the ingredients are solids dispersed in liquid solubilized ingredients or a composition of either of the aforementioned and also a solid layer of solid ingredients.

The ingredients of the Al⁺³PO₄ solution are present in amount ranges which enable them to perform their function, but not in an amount which has an adverse effect on the basecoat of the multi-ply coating. The following is descriptive of an Al⁺³PO₄ solution effective for use in the practice of the present invention.
about 15 to about 40 wt. % phosphoric acid;
about 0.1 to about 1.5 wt. % aluminum ion, and
about 45 to about 75 wt. % water.

The Al⁺³PO₄ solution can include optional ingredients to adjust its properties or to impart to the solution and the ply formed therefrom properties which are desirable. Optional ingredients include a buffering agent to adjust the pH of the solution as desired. Examples of buffering agents include Mg ion supplied from Mg hydroxide or Mg oxide or Mg carbonate. A basic organic buffering agent may be used, for example, diethanolamine.

The amount of optional ingredient included in the solution depends on the nature of the ingredient, that is, the function it performs in the solution. An exemplary amount of the optional ingredient falls within the range of about 0.1 to about 2.5 wt % of the solution.

In one embodiment, the Al⁺³PO₄ solution comprises 25.7% phosphoric acid, 1.4% aluminum ion, and 2.1% magnesium ion (Mg++) with the remainder being water (72.1%). The pH of this solution is above 2.6.

The prior art discloses Al⁺³PO₄ solutions which are Cr-free and which may be used in accordance with the present invention; examples are described in patents identified below.

U.S. Pat. No. 5,242,488 discloses an Al⁺³PO₄ solution formed by reacting aluminum metal with dilute phosphoric acid. Other examples of Al⁺³PO₄ solutions saturated with respect to aluminum ion are disclosed in U.S. Pat. Nos. 5,279,649 and 5,279,650 and 5,478,413. U.S. Pat. Nos. 5,652,064 and 5,803,990 disclose such solutions which contain zinc and borate ions. In addition, U.S. Pat. No. 5,968,240 discloses an Al⁺³PO₄ solution of which contain nitrates. U.S. Pat. No. 6,074,464 discloses an Al⁺³PO₄ solution which contains potassium permanganate, magnesium carbonate, and aluminum nitrate. Other examples of Al⁺³PO₄ are disclosed in U.S. Pat. Nos. 7,789,953 and 7,993,438. U.S. Pat. Nos. 6,224,657 and 6,368,394 disclose Al⁺³PO₄ solutions that include trivalent chromium which is considered presently as being environmentally acceptable.

Preferred Al⁺³PO₄ solutions are those saturated with trivalent aluminum ion (Al+3) that have been buffered by addition of magnesium ion (Mg⁺²) to a pH greater than 1.5, preferably >2. The particularly preferred are those that have been buffered with magnesium hydroxide to a pH >about 2.5.

In accordance with the present invention, sufficient Al⁺³PO₄ solution should be applied to the basecoat to saturate its surface. The Al⁺³PO₄ solution is typically sprayed on to its surface until its surface is wet. The solution may be applied by brushing or dipping as well as by spraying.

The Al⁺³PO₄ solutions are typically clear and colorless; it is within the scope of this invention to add metallic oxide pigments including, for example, fumed oxides and color pigments to such solutions to heighten their contrast with the basecoat. Adding color to the phosphate solution makes it easier to see where the basecoat has been adequately treated when the solution is being applied to the basecoat. The process of burnishing the surface can continue until the surface of the basecoat is returned to a white grey aluminum color.

Care should be used, however, in the use of pigment in the solution. Pigment that is smaller in diameter than the average diameter of pores in the surface of the basecoat can fill those pores blocking flow of the solution into the depths of the basecoat. Also excess amounts of any size pigment to the solution can impede flow by piling up on the surface of the basecoat to create a physical barrier to absorption of the liquid.

In preferred form, the viscosity of the Al⁺³PO₄ should be less than about 30 seconds as measured by a #2 EZ Zahn cup, and preferably less than about 20 seconds. The average size of the pigment particles in the Al⁺³PO₄ solution should be preferably greater than about 0.5 micron in diameter and more preferably greater than about 1 micron.

In the event of using fumed oxides and colloidal suspensions of silica in the Al⁺³PO₄ solution, it is recommended that care be taken to avoid their increasing the viscosity of the solution to the extent that they reduce the ability of the solution to infiltrate the basecoat and to inhibit complete cure of the basecoat.

In one preferred embodiment of the invention, black and yellow pigments were added to an Al⁺³PO₄ solution that had a pH adjusted to 2.6 by the addition of magnesium hydroxide. The amount of pigment was adjusted to about 4.0% of the total wt. of the solution. The average diameter of the black pigment used was 1.4 microns. The yellow pigment was 2.2 microns in diameter on average.

A particularly preferred embodiment of the invention involving the use of pigments comprises adding to the (Al⁺³PO₄) described as Solution S1 in Example 1 the following: 2% by wt. of yellow metal oxide pigment (averaging 1.4 μm in diameter) and ˜2% by weight of black metal oxide pigment (averaging 2.2 μm in diameter).

After the basecoat has been saturated with the Al⁺³PO₄ solution, the wet surface thereof is dried and then cured. The term “cured” means a wet surface that has removed therefrom both the bound and unbound water thereof under conditions which form a solid coating that is not conductive. Typically, the coating solution is heated to accelerate evaporation thereof and complete its conversion to a solid, insoluble form.

In one embodiment of this invention, the Al⁺³PO₄ solution is dried in air for at least 15 minutes before being placed in an oven preheated to around 175° F. (80° C.) and held until the basecoat has been at that temperature for at least about 15 minutes. The part covered with the dried, treated aluminum-silicate coating of the present invention is then heated to about 650° F. (343° C.) and held at that temperature until the basecoat has an overlying ply that comprises an insoluble solid that is not conductive. The conditions of curing can be adjusted as needed to form the non-conductive ply.

Mechanical Treatment of the “Al⁺³PO₄”

After formation of the non-conductive ply, its surface is worked by mechanical means: to; 1) remove residual cured phosphate that may be on its surface and; 2) convert the ply to conductive form. Such working is referred to herein as “burnishing”. Blasting the non-conductive ply with abrasive media like aluminum oxide grit or glass beads renders it electrically conductive. In preferred form, it is blasted with fine aluminum oxide of 180 to 240 grit.

The exact mechanism of this electrical transformation is not completely understood. It is believed that burnishing exposes clean aluminum on the surface of the ply and slightly compresses it forcing aluminum particles within the ply.

The use of burnishing in connection with aluminum-chromate/phosphate coating systems is known to achieve electrical conductivity. The size and nature of the blasting media can vary widely. It is well known to vary blast pressure, stand-off distance, and dwell time to assure that the satisfactory work is done to make the coating layer conductive, while not physically damaging it. It is also known that adequate burnishing has been done when the electrical resistance of the coating layer measures less than 20 ohms, preferably, less than 15 ohms, ideally less than 10 or 5 ohms.

When the Al⁺³PO₄ solution applied in Step (C) of the present invention is colored with pigment, the process of burnishing the surface in Step (E) should continue until the surface is returned to a light gray color.

For the purposes of this invention, Step (E) has been satisfactorily performed when the electrical resistance of the burnished basecoat measures less than 20 ohms between two ohm meter probes placed lightly on one-inch (25 cm) apart on the surface.

Application of Additional Al⁺³PO₄ Solution

As set forth in Step (F) above, the conductive ply prepared by the burnishing of the aforementioned non-conductive ply formed by curing the Al⁺³PO₄ solution is treated with another Al⁺³PO₄ solution (hereafter referred to as “the added Al⁺³PO₄”) whose ingredients and amounts thereof can be the same as or different from the various Al⁺³PO₄ solutions described above, including mixtures of two or more of the solutions. The added Al⁺³PO₄ solutions can include optional ingredients and amounts thereof as described above and, upon being cured according to Step (G) above, forms the top coat of the multi-ply coating of the present invention. In addition to the optional ingredients described above, the initial and added Al⁺³PO₄ solution can contain also trivalent chromium (Cr⁺³) which is known to impart corrosion-resistant properties to compositions which are used to treat metallic substrates. Unlike toxic hexavalent chromium, Cr⁺³ is considered to be an environmentally acceptable material.

In a preferred embodiment of the invention, there is formulated with the added Al⁺³PO₄ solution a solution of chromium nitrate that is prepared, for example, by dissolving chromium oxide (CrO₃) in nitric acid, most preferably hot concentrated nitric acid. In another embodiment of the invention, the added Al⁺³PO₄ solution was heated and thereafter, there were added thereto anhydrous chromium nitrate and chromium nitrate nonahydrate were dissolved and the resulting composition was heated until all the aluminum had dissolved.

The added Al⁺³PO₄ solution is initially dried and then cured. The term “curing” means the formation of a solid coating that has a water-wet surface from which the chemically bound and unbound water are removed by heat in a way that renders the coating solid and insoluble and not conductive. This can be accomplished, for example, by drying the Al⁺³PO₄ treated surface in air before placing it in an oven preheated to around 175° F. (80° C.) and maintaining it at that temperature for at least 15 minutes. Thereafter the dried and heated topcoat is further heated to 65° F. (343° C.) and held at that temperature until the top coat is cured to an insoluble solid, for example, about 30 minutes. Upon being cooled, the surface of the cured topcoat of the multi-ply coating is not conductive. The aforementioned conditions involving time and temperature may be adjusted as needed to accommodate the needs of the part being coated.

An additional preferred embodiment of the present invention comprises a multi-ply coating that comprises Al⁺³PO₄ and trivalent Cr and nitrate and also a polymeric resin which functions to impart to the surface of the multi-ply coating a reduced coefficient of friction and/or improved resistance to wetting and fouling. Polymeric resins preferred for such a purpose include dispersions of PTFE or silicones in water.

Consideration should be given to the surface finish of the multi-ply coating of the present invention. The surface finish can have an effect on the corrosion-resistant properties and also on other properties of the coating, for example, how efficiently the coated article performs in use. (Surface finish is referred to in the art also as “surface texture” and “surface topography”.) Also as explained below, there are applications in which it is desirable that the surface finish of a multi-ply coating of the present invention has a particular type of surface finish, but first, a description of the meaning of “surface finish”.

Surface finish is defined typically by three characteristics, namely. (1) surface roughness (short-range ups and down), (2) waviness (longer range ups and down), and (3) lay (predominant direction of the undulations). These characteristics encompass surface deviations from a surface that is ideally perfectly flat, that is, a true plane.

Roughness, waviness, and lay can be imparted to the surface finish by various treatments, for example, grinding (abrasive cutting), polishing, lapping, and abrasive blasting.

Roughness, waviness, and lay of coated surfaces are typically measured using a stylus profilometer. A profilometer comprises a stylus in a probe which comprises a mechanism to move the probe a precise distance across a surface and also circuitry to measure and record up and down displacement of the stylus as the probe moves. The profilometer statistically analyzes the measured displacements to calculate known parameters that characterize the surface properties. These parameters are defined in several standards, including ANSI/ASTM B46.1, Surface Texture (Surface Roughness, Waviness, and Lay), which is incorporated herein by reference.

Roughness and waviness of a coating used on turbine engine components are typically characterized by “roughness average” (Ra) expressed in microinches or microns, at a specific measurement “cutoff” in inches or millimeters. Cutoff prescribes how far the probe moves before the profilometer sums and arithmetically manipulates detected stylus displacements. Aforementioned ASTM B46.1 explains that, at a specific cutoff, the probe of the profilometer will move 3 or 5 times the cutoff distance compiling displacement data taken for each cutoff distance. For example, when taking measurements at a 0.010″ cutoff, the probe moves 0.05″ (5×0.01″) and records the average of five (5) separate averages of stylus displacement over sequential 0.010″ lengths of the surface. At 0.030″ cutoff, the probe moves 0.15″ and records the average of five (5) separate averages of stylus displacement over each 0.030″ of the surface. The higher the cutoff, the longer the traverse and the more waviness (long range roughness) is added to the calculated roughness average, Ra).

As referred to above, manufacturers of gas turbine engines that are used for power generation are concerned with the degree of Ra of the surface. They prefer or even require that the surface finish of coated gas path components (components over which air flows) be <40 Ra at a 0.010″ cutoff (<1.0 μm @0.25 mm) to assure aerodynamic efficiency of those devices. Surface finish requirements for flight turbine components can be more demanding, as smooth as <15 Ra at an 0.010″ (<0.38 μm @ 0.25 mm) cutoff.

In contrast to the above surface finishes of roughness and waviness which include surface deviations, the “lay” surface finish is a substantially flat surface.

Taking into account the above information, a preferred practice of the present invention should involve providing a process which is tailor-made to protect efficiently a particular application for which the multi-ply coating of the present invention is to be used. There follows a description of how to accomplish this, for example, by formulating ingredients of individual composition(s) used in forming a particular ply of the multi-coating and/or adjusting the curing conditions which form a ply.

As stated above, manufacturers of gas turbine engines that are used for power generation typically require that the surface finish of coated components over which air flows have a high level of smoothness to assure aerodynamic efficiency (referred to hereafter as “aerodynamically smooth”).

For use in such applications involving gas turbine engines and flight turbine components, a preferred embodiment of this invention utilizes an Al⁺³PO₄ solution in Step (F) to which trivalent chromium and nitrate have been added; such a solution contains substantially more Al⁺³ ion than can be incorporated into phosphoric acid alone and cures to a glassy solid film. Not only are multi-ply coatings using this Cr⁺³-nitrate/Al⁺³PO₄ solution aerodynamically smooth, they are stable in hot water and water vapor, and they are also corrosion-resistant. The surface finish of a coating system of the present invention made using a chromium-nitrate Al⁺³PO₄ topcoat solution in Step (F) meets or exceeds typical turbine manufacturer requirements and flight turbine components for roughness of coated surfaces.

Accordingly, another aspect of the present invention is the provision of a composition which comprises chromium nitrate and the use thereof.

In addition to its use as described above, the Cr⁺³ nitrate composition can be used also in other applications because of its ability to form coatings which are corrosion-resistant and which have other desirable properties. Accordingly, another embodiment of the present invention includes a liquid coating composition comprising trivalent chromium, and nitrate, for example, in aqueous form.

### EXAMPLES

There are described hereafter three examples which are exemplary embodiments of the present invention. All of the compositions described in the examples are Cr⁺⁶Free.

### Example 1

In brief, this example describes the production of a multi-ply coating system in which carbon steel coupons were treated sequentially to the following four basic steps:
(1) the formation of an aluminum-containing silicate basecoat that was not conductive; (2) the formation on the surface of the basecoat of an initial trivalent aluminum-phosphate coating (Al⁺³PO₄) that was not conductive; (3) the burnishing by mechanically working the surface and the Al⁺³PO₄ coating to convert it to a conductive form; and (4) the formation on the conductive coasting of step (3) hereof of a non-conductive coating comprising Al⁺³PO₄. The amounts of the ingredients of the coating compositions are given in wt. % based on the total weight of the compositions unless stated otherwise.

Two sizes of carbon steel coupons were selected for this example. The smaller panel measured 2″×3.5″×0.32″ (51 mm×89 mm×0.8 mm) and the larger one measured 3″×5″×0.32″ (76 mm×127 mm×0.8 mm). Both sizes of these coupons will be referred to hereinafter as “Panel 1”.

The panels were heated for at least 15 minutes at 650° F. (345° C.) to burn away any oils and then blasted with 120-grit brown aluminum oxide at 80 psi (650 kPa) in a suction blast cabinet.

Residual blasting media was blown from blasted surfaces with clean compressed air.

Step (A)—Apply Aluminum-Silicate Basecoat

An aluminum-silicate slurry was applied to the cleaned and blasted steel coupons. The slurry was like that described in U.S. Pat. No. 9,739,169. It comprised fine aluminum powder dispersed in an aqueous liquid bonding solution of sodium silicate and lithium silicate.

| | |
|---|---|
| a) sodium silicate | 6.9% |
| ratio of silica (SiO2) to sodium oxide (Na2O) of 2.5 to 1; | |
| b) lithium polysilicate | 3.5% |
| ratio of silica (SiO2) to lithium oxide (Li2O) of 10 to 1; | |
| c) water; | 45.3% |
| d) amorphous silicon dioxide; and | 1.6% |
| e) aluminum powder, 4.5 to 6.5 microns (average diameter), | 42.7% |
| ratio of silicate to aluminum by weight, 0.23 to 1. | |

The aqueous solutions of sodium silicate and lithium polysilicate were first combined with water. Aluminum powder was then blended into the mixture until it all was thoroughly dispersed. The final mixture was screened through a 325-mesh wire sieve.

The aluminum-silicate slurry was applied to the coupons using a DeVilbiss™ EGHV-531 HVLP air-atomizing siphon spray gun with an E-tip and fluid nozzle with a 1.1 mm opening.

Step (B)—Cure Aluminum-Containing Silicate Basecoat

Coupons coated with the liquid aluminum-silicate composition described in Step (A) were dried in air, then heat dried at 175° F. (89° C.) for at least 15 minutes before being baked at 650° F. (345° C.) for at least 35 minutes to cure the silicate into a solid aluminum-ceramic film. The coupons were removed from the oven and cooled.

When the panels had cooled, steps (A) and (B) were repeated to deposit a second aluminum-ceramic layer on the coupons. The two separately cured coats of aluminum-silicate on the coupons were about 2.3 to 3.0 mils (58 to 76 microns) thick. This layer of cured aluminum-silicate was not conductive. In other words, when probes of an ohmmeter were placed one inch (25 cm) apart on the coated surface, no current flowed and no reading registered on the device.

Step (C)—Apply to the Non-Conductive

Basecoat Cr-Free Al⁺³PO₄ Coating Solution

A chromium-free dilute aqueous solution of phosphoric acid saturated with trivalent aluminum ion (Al⁺³) was prepared comprising:

| | |
|---|---|
| water | 61.5% |
| 75% phosphoric acid | 34.25% |
| Aluminum hydroxide | 4.25% |
| (J.M. Huber Corp., Onyx Elite ® 431). | |

Phosphoric acid was added to water and the aqueous solution thereof was heated to about 150° F. (66° C.). Aluminum hydroxide was then added gradually so that the temperature of the solution never exceeded 190° F. (88° C.). Stirring was stopped once all aluminum hydroxide had dissolved in the phosphoric acid solution and the mixture was allowed to cool to less than 100° F. (38° C.). The phosphoric acid solution saturated with aluminum ion contained 34.25% of 75% phosphoric acid, 4.25% of aluminum trihydrate, and 61.50% of water.

Magnesium oxide was added to the aforementioned solution to buffer it. The magnesium hydroxide was stirred into the aqueous solution a bit at a time. When the solution had clarified, its pH measured >2.6 at 76 to 78° F. (24.5 to 25.5° C.). The buffered solution was passed through a 500-mesh wire screen. Nothing was retained on the sieve. The resulting solution (S1) comprised the following ingredients:

| | |
|---|---|
| Al⁺³-phosphate bonding solution, A1 | 89.3% |
| magnesium hydroxide | 4.7% |
| water | 6.0% |

Before this solution was applied to the cured aluminum-silicate basecoat, a blend of organic solvents (84 wt. % propylene glycol monomethyl ether acetate and 16% tripropylene glycol methyl ether) was added to aid wetting. One (1) part solvent by volume was added to ten (10) parts of the solution.

A DeVilbiss EGA-503 air-atomizing spray gun with an F-tip (<0.9 mm diameter opening) and fluid needle was used to apply a thin wet coat of the S1 treatment solution onto the surface of the cured aluminum-silicate basecoat. The solution was sprayed onto the surface in multiple passes until the surface took on a uniform sheen. Any wetness disappeared quickly as the solution S1 soaked into the cured aluminum-silicate basecoat. After the first mist coat of S1 had dried for a few minutes, a second coat was applied until the surface again took on a uniform luster. This was repeated until the surface stayed mostly wet with solution S1 even after sitting for one minute.

Step (D)—Heat Cr-Free Aluminum Phosphate Coating Solution

The cured aluminum-silicate basecoat that had been treated with solution S1 in step (C) was dried at ambient for at least 5 minutes and then transferred to an oven preheated to 175° F. (89° C.). After 15 minutes, the set point of the oven was raised to 650° F. (345° C.) and the coupons which had thereon the cured aluminum-silicate basecoat with absorbed S1 were heated to that temperature and held for 35 minutes to form a solid, cured, modified composite.

When the coupons had cooled, conductivity of the modified composite was measured using probes of an ohmmeter as described in Step (B). The surface was not conductive.

Step (E)—Mechanical Treatment of the Non-Conductive Modified Composite

When the coupons had cooled, the surface of the modified composite deposited in Steps (A) thru (D) was lightly blasted with 240-grit aluminum oxide at 40 psi (380 kPa) in a suction blast cabinet; a process called burnishing.

Upon burnishing, the surface of the modified composite became brighter in color and slightly reflective. Impinging burnishing media removed residual cured solution S1 from the surface of the modified composite.

Touching to the surface two probes of an ohmmeter held one-inch (25 cm) apart on the surface confirmed that burnishing also lowered the electrical resistance of the surface of the modified composite to merely 0.5 ohm, making the composite coating conductive. Burnishing also compressed the composite slightly, reducing its thickness by roughly 0.2 mils or 5 microns on average.

Step (F)—Apply to the Conductive Composite

Coating an Additional Coating Al⁺³PO₄ Solution

A khaki-colored Al⁺³PO₄ solution (B1) containing nitrate ions was made as follows:

| | | |
|---|---|---|
| water | 117.8 | gm |
| 75% Phosphoric Acid | 65.52 | gm |
| Aluminum Hydroxide | 16.51 | gm |
| J.M. Huber Corp., Onyx Elite ® 431 | | |
| Chromium(III) nitrate nonahydrate, 98.5% (solid) | 48.52 | gm |
| Alfa Aesar, CAS 7789-02-8. | | |

The phosphoric acid was added to the water in a glass flask on a combined hot plate/magnetic stirrer. A magnetic stir bar was added. Chromium nitrate crystals were added as the solution stirred. The phosphoric acid-nitrate solution was covered and heated to between 150° and 160° F. (66° and 71° C.) while stirring. The crystals dissolved completely in the acid, turning the clear, colorless liquid dark violet-green.

Aluminum hydroxide was stirred into the hot solution. It was added incrementally so its temperature did not exceed 190° F. (88° C.). (Dissolution of aluminum hydroxide in the acid is exothermic. If the solution gets too hot, insoluble reaction products form.) After all the aluminum hydroxide had been added, the hot solution was covered and stirred for an hour and a half at 160° to 170° F. (71° to 77° C.). Afterwards it appeared clear, but when it had cooled and sat overnight, a fine layer of white powdery aluminum hydroxide covered the bottom of the flask.

The mixture was set to stirring again and heated back to 160° to 170° F. (71° to 77° C.). After the phosphoric acid, trivalent chromium nitrate and aluminum hydroxide had been stirred for five hours at the elevated temperature, the hot plate was turned off. A 15 ml sample was taken from the hot mixture and placed in a glass vial. The flask was covered again and allowed to stir on the plate as it cooled.

No white particulate was seen on the bottom of the glass vial when the solution had cooled to room temperature. When the flask had cooled, its contents were poured through a 635-mesh stainless steel wire sieve. Little if any particulate was captured on the screen, indicating that all the aluminum hydroxide had dissolved in the solution.

Properties of the Solution at 77° F. Measured:

| pH | 0.6 | |
|---|---|---|
| Density (lb./gal.) | 10.9 | lb./gal. |
| Viscosity (#2 GE Zahn) | 17 | sec. |

The solution contained 25% by weight solids which were determined by heating the solution for 30 min. at 175° F. and 30 min. at 650° F.

Testing showed that solution B1, made with chromium nitrate as described, contained less than 1 ppm hexavalent chromium, making it Cr⁺⁶Free.

Blue, brown and yellow pigments, along with colloidal silica, were added to the additional Al⁺³PO₄ solution to make a slurry (T1) that could be sprayed and applied to the grit-burnished conductive composite coating formed in Step (F) of this embodiment of the invention.

| | |
|---|---|
| Solution B1 (Cr⁺³/Al⁺⁺⁺-phosphate) | 83.2% |
| colloidal silica | 0.85% |
| (Ludox ® SM 30% solution, W.R. Grace Co.) | |
| Cobalt aluminate blue pigment | 2.4% |
| (Shepherd # 214 blue, Shepherd Color Co.) | |
| Nickel antimony titanate yellow pigment. | 9.8% |
| (Shepherd # 101-C112E yellow, Shepherd Color Co.) | |
| Iron titanate brown pigment | 3.75% |
| (Shepherd # 10P858 brown, Shepherd Color Co.). | |

After blending for 30 seconds, the slurry T1 was screened through a 500-mesh stainless steel wire sieve. (Essentially no residue was retained on the sieve.)

The resulting composition was sprayed onto the burnished surface of the conductive composite using a DeVilbiss EGA-503 siphoning spray gun with an F-tip. Three thin coats were applied, thoroughly drying each between coats, until the surface became uniform in color and remained shiny after it dried. After the coated coupons were dried to the touch, they were transferred to an oven preheated to 175° F. (89° C.). After 15 minutes, the set point of the oven was raised to 650° F. (345° C.). The coupons were heated to the set point and held at that temperature for 35 minutes to cure the top coating.

The thickness of the finished multi-layer composite coating of this example of the invention ranged from 2.5 to 3.3 mils (78 to 84 microns) on average. The topcoat itself was 0.3 to 0.5 mils (8 to 13 microns) thick and it was not conductive.

### Example 2

In another embodiment of this invention, carbon steel panels were coated with a multi-layered coating system described in Example 1 except for the following differences. In Example 1, the initial Al⁺³PO₄ coating solution utilized in Step (C) of Example 1 did not contain trivalent Cr or nitrate and the “additional” Al⁺³PO₄ solution contained both trivalent Cr and nitrate. In Example 2 hereof both the initial Al⁺³PO₄ solution and the “additional” Al⁺³PO₄ solution did not contain trivalent Cr and nitrate.

Accordingly, this example demonstrated that the present invention can be used effectively in practicing both the embodiments of Examples 1 and 2.

There follows an additional description of information respecting details of Example 2.

Two sizes of carbon steel panels were the subject of this example. The smaller panel measured 2″×3.5″×0.32″ (51 mm×89 mm×0.8 mm) and the larger 3″×5″×0.32″ (76 mm×127 mm×0.8 mm). Both sizes of these panels will be referred to hereinafter as “Panel 2”.

Both panels were prepared exactly as carbon steel coupons had been prepared for Example 1. The aluminum-silicate slurry applied in Step (A) of this Example was identical to that used in Example 1. Cure times and temperatures in aforementioned Steps (B), (D) and (G) were identical to those used in Example No. 1, as were the grit size and blasting pressure used to burnish the treated basecoat. However, in Example 2 hereof a khaki-colored solution completely free of both chromium and nitrate ions (“T2”) was prepared by adding to the Al⁺³PO₄ ingredients blue, brown and yellow pigments, and also fumed silica identified below:

| | |
|---|---|
| Solution S1 | 83.2% |
| Fumed silica | 0.85% |
| (Aerosil 200, Evonik Corp.) | |
| Cobalt aluminate blue pigment | 2.4% |
| (Shepherd # 214 blue, Shepherd Color Co.) | |
| Nickel antimony titanate yellow pigment | 9.8% |
| (Shepherd # 102-C112E yellow, Shepherd Color Co.) | |
| Iron titanate brown pigment | 3.75% |
| (Shepherd # 10P858 brown, Shepherd Color Co.). | |

This mixture was blended for 30 seconds and then screened through a 500-mesh stainless steel wire sieve. (Little residue was retained on the sieve.)

The blend of organic solvents used in Step (C) of Example 1 (84 wt. % propylene glycol monomethyl ether acetate and 16% tripropylene glycol methyl ether) was added to this screened, khaki-colored slurry. As in Example 1, one (1) part solvent by volume was added to ten (10) parts of the topcoat made from solution S1.

The khaki mixture was sprayed onto the surface of the burnished, conductive composite coating using a DeVilbiss EGA-503 siphoning spray gun with an F-tip. Three thin coats were applied, thoroughly drying each between coats, until the color and luster of the surface was uniform. When dry to the touch, the panels topcoated with T2 were baked for 15 minutes at 175° F. (89° C.). The temperature of the oven was then raised to 650° F. (345° C.) and held for 35 min. to cure the completely chromium-free khaki topcoat.

The thickness of the finished multi-layer composite coating was about 2.6 to 3.0 mils (66 to 78 microns) on average. The topcoat itself was about 0.3 to 0.5 mils (8 to 13 microns) thick. The topcoated and cured surface was not conductive.

### Example 3

This example demonstrates that the multi-ply coating system that was formed on carbon steel panels as described in Example 2 is similarly effective when applied to a stainless steel substrate typical of that used to manufacture turbine engine components.

In this example, the multi-ply coating system described in Example 2 was applied to two panels made of Jethete™ martensitic stainless steel. (One panel measured 38×70×1.5 mm. The other panel measured 70×150×1.5 mm.) and comprised Jethete which is a 12% Cr alloy steel. It is typical of those alloys used to make compressor blades and vanes for gas turbine engines.

The stainless steel panels were prepared and coated in the same way as the carbon steel panels identified as Panel 2 in Example 2. The two Jethete panels coated in this example are referred to hereafter as Panel 3, irrespective of their size unless stated otherwise.

Panel 3 panels were evaluated in 1) hot deionized (DI) water and 2) in 5% neutral salt fog.

Panel 3 panels were partly immersed in 140 mL of hot DI water in a glass beaker. The beakers and its contents were sealed with plastic films and the beakers placed in an oven preheated to 80° C. and allowed to rest at that temperature for 100 hrs. After 100 hrs. in the hot DI water, the multi-ply coatings were largely unaffected, showing no blisters. Though some white material leached from the exposed or outer surface of the multi-ply coating, the water remained clear throughout the test.

The conditions of the panels and hot water remained unchanged through 500 hrs., at which time the test was terminated.

With respect to the salt fog test of the larger panel, an “X” was scribed through the outer surface of the multi-ply coating on one side of the larger Panel 3 panel. After the edges of the panel had been waxed, it was placed in a 5% neutral salt fog cabinet operating per ASTM B117 as salt fog condensed on the scribed surface.

Through 3000 hrs. in 5% neutral salt fog per ASTM B117, no red rust was observed anywhere on panel 3; the multi-ply system that was used to form the Panel 3 hereof remained tightly adhered on the front and back of the panel.

With reference to the three examples hereof, Example 1 and Example 2 are distinguishable in that the Al⁺³PO₄ solutions used in the multi-ply coating system of the present invention are different; Example 3 hereof distinguishes over Examples 1 and 2 in that the substrate coated in Example 3 is different from the substrates coated in Examples 1 and 2.

Various tests have been performed on the three multi-ply embodiments that have been made using the coating system of the present inventions. Such tests have included evaluations of the corrosion-resistant and other properties of the embodiments. The results of such tests have revealed that, relative to prior art developments, properties of embodiments of the present invention possess improved properties, including in various cases, significantly improved properties. And uniquely significant is that such properties are achieved by the use of compositions and techniques of application that are environmentally acceptable—no need to practice the present invention by having to use, for example, toxic hexavalent chromium.

### Example 4

This is an example of the present invention and is identical to that of Example 1 except that the sequence of Steps (A) and (B)—that is, the application and cure of the aluminum-silicate basecoat layers—differs in this example.

Example 1 describes an embodiment of the present invention that is a multi-ply coating utilizing two coats of aluminum-silicate basecoat that are sprayed and cured separately. However, it is widely known in the art to spray a single coat of an aluminum-filled chromate/phosphate slurry onto a prepared surface in order to allow that layer to dry in air and then to spray on a second coat of slurry to wet the coated surface a second time. After that second coat has dried in air again, it is known to heat dry and cure the coating at an elevated temperature. Applying two coats of basecoat with a single heat cure is often known in the art as “wet-on-wet” application.

This example utilizes a wet-on-wet application of the same aluminum-silicate basecoat used in previous Examples 1, 2 and 3; it shows that the hot water stability and corrosion-resistance of the present multi-ply coating system incorporating a wet-on-wet basecoat is comparable to that of a system in which the basecoat is applied in two separately cured coats.

As was the case in Examples 1 and 2, carbon steel (CS) panels coated for this example were of two different sizes. The smaller panel (referred to hereinafter as a “small CS panel”) measured 2″×3.5″×0.32″ (51 mm×89 mm×0.8 mm) and the larger one (“large CS panel”) measured 3″×5″×0.32″ (76 mm×127 mm×0.8 mm). Two coats of aluminum-silicate slurry were applied to grit-blasted panels in the wet-on-wet manner described above. One small CS panel and two large CS panels are referred to as “Panel 4” hereafter.

A single coat of aluminum-silicate slurry like that disclosed in U.S. Pat. No. 9,739,169 was applied to the Panel 4 panels as in Step (A) of Example 1.

After the wet coat of aluminum-silicate had dried, a second coat of the same slurry was sprayed onto the panels until a uniformly wet finish was again achieved. After drying in air, the panels were dried for at least 15 minutes at 175° F. (79° C.) before being cured at 650° F. (343° C.) for 30 minutes as in Step (B) of Example 1.

The Al⁺³PO₄ bonding Solution S1 which is described in Example 1 was applied to the cured wet-on-wet aluminum-silicate basecoat on the Panel 4 panels in accordance with Step (C) as described in Example 1. (No solvent was mixed with Solution S1 before it was sprayed onto the cured aluminum-silicate basecoat as had been done in Example 1.)

The treated, cured wet-on-wet coat of aluminum-silicate basecoat was then baked at 650° F. (343° C.) as in Step (D) of Example 1.

The cured aluminum-silicate composite was lightly blasted (“burnished”) with 240-grit alumina abrasive grit at 40 psi in a suction blast cabinet as in Step (E) of Example 1. After burnishing, electrical resistance between two probes placed at least 1-inch (25.4 mm) apart on the coated surface measured <5 ohms.

The Al⁺³PO₄ topcoat described in Example 1 (hereafter “solution T1”) was applied over the cured, conductive coating, that is, in Step (F) of this example. The topcoat was cured at 650° F. (343° C.) as in Step (G) of Ex. 1 to provide a top coated surface that was not electrically conductive.

### Comparative Example for Hot Water Test. Panel 4-C1

Another small CS panel was cleaned, grit-blasted, and coated with the same materials in the same manner as used for Panel 4 panels except that Steps (C) and (D) were omitted. This comparative example is referred to hereafter as “Panel 4-C1”.

TABLE Ex. 4.A below shows the steps used in the formation of Panels 1, 4, and 4-C1.

TABLE Ex. 4.A
Process Steps for Hot Water Test Panels of Ex. 4

| | | | | Panel |
|---|---|---|---|---|
| STEP | DESCRIPTION | Panel 1 | Panel 4 | 4-C1 |
| A1 | Apply Al-silicate slurry and air dry | X | X | X |
| B1 | Bake Al-silicate | X | | |
| | (30 min. @ 650° F./343° C.) | | | |
| A1 | Apply Al-silicate slurry and air dry | X | X | X |
| B1 | Bake Al-silicate | X | X | X |
| | (30 min. @ 650° F./343° C.) | | | |
| C1 | Apply Solution S1 (with no solvent) | X | X | |
| D1 | Bake Treated Al-Silicate | X | X | |
| | (650° F./343° C.) | | | |
| E1 | Burnish Until <5 ohms | X | X | X |
| F1 | Apply Topcoat T1 (<1 ppm Cr⁺⁶) | X | X | X |
| G1 | Bake Composite (650° F./343° C.) | X | X | X |

The properties of Panels 4 and 4-C-1 were evaluated in hot deionized (DI) water. Panel 4 and Panel 4-C1 were sealed in separate beakers partially filled with hot DI water and placed in an oven at 80° C. (176° F.) for 100 hr., as described in Example 1. The multi-ply coating system on Panel 4-C1 blistered above and below the waterline. The coating on Panel 4 was unchanged. No material had leached from the coated surface. No chalky white deposits were observed on the panel or in the water in the beaker.

Panel 4 was returned for further testing. When testing was terminated after 1000 hours, the coating on Panel 4 was still tightly bonded everywhere on the panel. The “test” performance of Panel 4 was equivalent to that of Panel 1.

### Comparative Example for Sacrificial Corrosion Test, Panel 4-C2

Two large CS panels were cleaned, grit-blasted, and coated with the same materials and in the same manner as used for Panel 1, (Example 1). These two comparative examples are referred to hereafter as “Panels 4-C2”.

Process steps used in the evaluation of the corrosion-resistance of Panel 4 and Panel 4-C2 are shown in TABLE Ex. 4.B. below.

TABLE Ex. 4.B
Process Steps for Corrosion Test Panels of Ex. 4

| | | | Panels |
|---|---|---|---|
| | | | 4-C2 |
| STEP | DESCRIPTION | Panels 4 | (Ex. 1) |
| A1 | Apply Al-silicate slurry and air dry | X | X |
| B1 | Bake Al-silicate (30 min. @ 650° F./343° C.) | | X |
| A1 | Apply Al-silicate slurry and air dry | X | |
| B1 | Bake Al-silicate (30 min. @ 650° F./343° C.) | X | X |
| C1 | Apply Solution S1 (with no solvent) | X | X |
| D1 | Bake Treated Al-Silicate (650° F./343° C.) | X | X |
| E1 | Burnish Until <0.5 ohms | X | X |
| F1 | Apply Topcoat T1 (<1 ppm Cr⁺⁶) | | X |
| G1 | Bake Composite (30 min. @ 650° F./343° C.) | X | X |

The corrosion-resistance of the above panels was determined using salt fog. An “X” was scribed through the coating layer on one side of Panels 4 and 4-C2 so that the substrate was exposed in the scratch and the panels were placed in a 5% salt fog cabinet per ASTM B-117 for 2500 hr.)

The results of the testing showed that there was little difference in the appearance of the four examples of two embodiments of the invention through 1000 hours in salt fog. No red rust had formed on any panels. After 2500 hrs. in salt fog, some red rust was observed in the scribe on one Panel 4 panel and one Panel 4-C2 panel. Apart from slightly more sacrificial white corrosion on panels with wet-on-wet basecoat (Panel 4), there was little difference between the two embodiments of this invention.

The tests demonstrated that, for a coating system of this invention, the aluminum-silicate basecoat may be applied either in two layers with a single cure or in two separately cured coats.

### Example 5

This is an example of the present invention involving the coating of carbon steel (CS) panels like those described in Example 1. The steps used in the coating of the panels included the step of overcoating a conductive layer of aluminum-ceramic with a second non-conductive layer of the same material which is a step known in the prior art for Al-chromate/phosphate coatings. It is a step referred to in the formulation of a “Class 3” coating; it was first described in U.S. Military specification, MIL-C-81751B (now inactive) which is incorporated herein by reference.

A small carbon steel (CS) panel and a large CS panel were coated with an embodiment of this invention in which the aluminum-silicate basecoat was in the Class 3 condition. These steel panels are referred to hereafter as “Panel 5” panels regardless of size.

A single coat of aluminum-silicate slurry like that disclosed in U.S. Pat. No. 9,739,169 was applied to Panel 5 panels as described in Step (A) Example 1 and then cured at 650° F. (343° C.) as in Step (B) of Example 1.

Before a second coat of aluminum-silicate was applied, as described in Examples 1, 2 and 3, a layer of Al⁺³PO₄ bonding solution S1 was applied to Panel 5 panels as in Step (C) of Examples 1, 2 and 3. The treated, single coat of aluminum-silicate basecoat was then baked at 650° F. (343° C.) (Step (D) of Example 1 to cure the layer and render it insoluble.

The single layer of cured, treated aluminum-silicate composite was lightly blasted (“burnished”) with 240-grit alumina abrasive grit at 40 psi in a suction blast cabinet (Step (E) in Examples 1, 2 and 3). After burnishing, electrical resistance between two probes placed at least 1-inch (25.4 mm) apart on the coated surface measured <5 ohms.

A second coat of aluminum-silicate slurry identical to the first applied in Step (A) was applied over this single conductive layer and then cured at 650° F. (343° C.)(Step (B)). The resulting surface was not electrically conductive.

The Al⁺³PO₄ topcoat (khaki-colored) used in Example 1, solution T1, was applied over this cured, non-conductive coating in Step (F) in this example. The system was cured at 650° F. (343° C.) in Step (G) to provide a top coated surface that was not electrically conductive.

### Comparative Example, Panel 5-C1

As a comparative example, identical carbon steel panels of both sizes, were cleaned, grit-blasted, and coated with the same materials in the same manner as described above except that Steps (C) and (D) were omitted. These comparative examples are referred to hereafter as “Panel 5-C1” regardless of size.

TABLE Ex. 5 below shows the steps used in the formation of the panels of Ex. 1, Panel 5, and P-5-C1.

TABLE Ex. 5
Coating Process for Panels of Example 5

| | | | | Panel |
|---|---|---|---|---|
| STEP | DESCRIPTION | Ex. 1 | Panel 5 | 5-C1 |
| A1 | Apply Al-silicate slurry | X | X | X |
| B1 | Bake Al-silicate (30 min. @ 650° F./343° C.) | X | X | X |
| C1 | Apply Solution S1 | | X | |
| D1 | Bake Treated Al-Silicate (650° F./343° C.) | | X | |
| E1 | Burnish Until <5 Ohms | | X | X |
| A1 | Apply Al-silicate slurry | X | X | X |
| B1 | Bake Al-silicate (30 min. @ 650° F./343° C.) | X | X | X |
| C1 | Apply Solution S1 | X | | |
| D1 | Bake Treated Al-Silicate (650° F./343° C.) | X | | |
| E1 | Burnish Until <5 Ohms | X | | |
| F1 | Apply Topcoat T1 (<1 ppm Cr⁺⁶) | X | X | X |
| G1 | Bake Composite (30 min. @ 650° F./343° C.) | X | X | X |

As in other examples, the above panels were compared in 1) hot deionized (DI) water and 2) corrosion-resistance in 5% salt fog.

As to the hot water stability test, the coating Panel 5 of the present invention was largely unchanged after 100 hrs. partly immersed and sealed in hot water. No material had leached from the surface. No chalky white deposits were observed on the panel. The water had remained clear.

By contrast, the multi-layered coating system of comparative example Panel 5-C1 had blistered and peeled below the waterline. Material that had exuded from the coating clouded the water in the beaker.

Panel 5 was further evaluated in the hot water test. After 500 hours, most of the water in the beaker had evaporated due to a breach in the seal, leaving a white stain on the back of the panel. The beaker was refilled, its seal restored, and the beaker was returned to test for another 700 hours at which time the test was terminated. The water remained clear through the balance of the test and there was no other change in the condition of the coating on Panel 5.

With respect to the evaluation of the corrosion-resistance, an “X” was scribed through the coating layer on one side of each large CS panel, so the substrate was exposed. The scribed, coated panels were then placed in a 5% neutral salt fog cabinet operating in accordance with ASTM B-117 so salt fog condensed on the scribed face of each.

The multi-ply coatings remained tightly bonded to the front and backs of Panel 5 and on Panel 5-C1 through 3000 hours in salt fog. There was no red rust on either panel. There was less white sacrificial aluminum corrosion on Panel 5 than on Panel 5-C1. The test was terminated at 3000 hr.

### Example 6

In another embodiment of the present invention, a multi-layered coating system was formed on carbon steel (CS) panels in a manner that was identical to that described in Example 1, except that a different aluminum-silicate basecoat slurry (“BC2”) was used in Step (A).

Two small CS panels and two large CS panels (Ex. 1) were coated with and were prepared exactly as panels were prepared and coated per Steps (A) through (G) used in Example 1, except that, in this example, the aluminum-silicate basecoat utilized a binder of lithium- and potassium-silicate instead of binder made with sodium- and lithium-silicate used in Example 1. Panels coated with this embodiment of the invention will be referred to hereinafter as “Panel 6” panels, regardless of size.

The aluminum-silicate basecoat comprises a slurry of fine aluminum powder in a lithium modified potassium-silicate binder as follows.

| Aluminum-Silicate Basecoat Slurry, BC2 | Wt. % |
|---|---|
| a) Aluminum Powder | 36.0% |
| (Eckart 407 grade air atomized | |
| aluminum powder) | |
| Average particle size: 5 microns | |
| b) Aqueous Lithium-Potassium Silicate | 41.2% |
| (PQ Corp. LITHISIL 829-29.7% | |
| silicate by weight) | |
| c) Water | 22.8% |
| Ratio of Silicate to aluminum by weight: | |
| 0.29 to 1.0 | |

The above ingredients were blended at high speed. When cool, the slurry was screened through a 325-mesh wire sieve. The slurry is like that disclosed as Formulation 58A in TABLE 1 of U.S. Pat. No. 9,017,464 (Belov '464).

This aluminum-silicate slurry was applied to panels in the same manner described in Step (A) of Example 1. After application, the aluminum-filled lithium-potassium-silicate basecoat was dried and cured at 650° F. (343° C.) per Step (B) of Ex. 1.

In Step (C) of this example, the cured basecoat on Panel 6 was treated with solution S1′.

| Treatment Solution, S1′ | Wt. % |
|---|---|
| a) Al⁺³PO₄ bonding Solution S1 of Ex. 1 | 96.5% |
| b) Shepherd #10C112E Yellow pigment | 1.6% |
| c) Shepherd #1 Black pigment | 1.9% |

Once Solution S1′ had been applied to the cured basecoat and allowed to dry in ambient air, the treated panel was cured as in Step (D) of Example 1.

After being burnished to <5 ohm electrical resistance as in Step (E) of Ex. 1, the Panel 6 panel was overcoated with Al⁺³PO₄ topcoat solution T1 as in Step (F) of Ex. 1 before being cured per Step (G) of that example.

### Comparative Example 1, Panel 6-C1

One small CS panel and two large CS panels were cleaned, grit-blasted, and coated with the same materials applied to the Panel 6 panels in like manner except that Steps (C) and (D) were omitted. These comparative examples are referred to hereafter as Panel 6-C1, regardless of size. Comparative testing is reported in Table 6 Ex. 6 below.

### Comparative Example 2, Panel 6-C2

A small CS panel was cleaned, prepped, and coated with the aluminum/lithium- and potassium-silicate basecoat described above. After curing, this basecoat was burnished with 240-grit abrasive in the same manner as used in Step (E) for Panel 6.

After Step (E), electrical resistance of the burnished aluminum-ceramic surface on Panel 6-C1 measured less than 0.5 ohm (electrically conductive) between two probes of an ohmmeter placed one-inch (25 cm) apart on the burnished surface.

### Comparative Example 3, Panel 6-C3

Another small CS panel was cleaned, prepped, and coated with the aluminum/lithium- and potassium-silicate basecoat described above and then cured at 650° F. as in Step (B) of Example 1. TABLE Ex. 6 shows the steps used in the formation of Panels 6, 6-C1, 6-C2, and 6-C3.

TABLE Ex. 6
Coating Process for Panels of Example 6

| STEP | DESCRIPTION | Panel 6 | 6-C1 | 6-C2 | 6-C3 |
|---|---|---|---|---|---|
| A2 | Apply Al/Li-K-silicate (Basecoat BC2) | X | X | X | X |
| B1 | Bake Al-silicate (30 min. @ 650° F./343° C.) | X | X | X | X |
| A2 | Apply Al/Li-K-silicate (Basecoat BC2) | X | X | X | X |
| B1 | Bake Al-silicate (30 min. @ 650° F./343° C.) | X | X | X | X |
| C1 | Apply Solution S1′ (with no solvent) | X | | | |
| D1 | Bake Treated Al-Silicate (650° F./343° C.) | X | | | |
| E1 | Burnish Until <5 Ohms | X | X | X | |
| F1 | Apply Topcoat T1 (<1 ppm Cr⁺⁶) | X | X | | |
| G1 | Bake Composite (30 min. @ 650° F./343° C.) | X | X | | |

Comparative examples 6-C1, 6-C2, and 6-C3 were subjected to hot water stability testing. The test results are reported below in Table Ex. 6.A below which summarizes the conditions of the panels at the end of this exposure.

The multi-ply coating on Panel 6 incorporating Al/lithium-potassium-silicate basecoat (an embodiment of the present invention) remained stable through 100 hr. in hot DI water. It did not blister or discolor. Panel 6 was returned to the test and remained unchanged through 1000 hrs. in hot DI water, at which time the test was terminated.

TABLE Ex. 6.A
Condition After 100 Hrs. in Hot DI Water

| | PROCESS STEPS | | | | | | | Blister Size, % of Area | | White | |
|---|---|---|---|---|---|---|---|---|---|---|---|
| Panel | A | B | C | D | E | F | G | Below H₂O | Above H₂O | Blooming | Water Clarity |
| 6-C3 | X | X | | | | | | None | None | None | 9 (clear) |
| 6-C2 | X | X | | | X | | | Fine, 20% | Large, 100% | None | 9 (clear) |
| 6-C1 | X | X | | | X | X | X | Fine, 20% | Large, 100% | None | 9 (clear) |
| 6 | X | X | | X | X | X | X | None | None | None | 9 (clear) |

Panels 6, 6-C1, 6-C2 and 6-C3 spent nearly 100 hrs. in an oven at 80° C. (176° F.) sealed in a beaker partially filled with hot DI water.

As sprayed and cured, lithium-potassium silicate basecoat alone (Panel 6-C3) was little affected by 100 hours in hot DI water, apart from some rust at the waterline. However, the basecoat that had been made electrically conductive by light abrasive blasting blistered badly in hot water. Burnished basecoat on Panel 6-C2 wrinkled badly above the waterline and blistered where it was immersed.

The multi-ply coating on Panel 6-C1 comprising burnished BC-2 basecoat with an overcoat of Topcoat T1 (Panel 6-C1) also wrinkled and blistered.

Table Ex. 6.B below reports the results of evaluating the corrosion-resistant properties of the panels. The evaluation consisted of scribing large Panels 6, 6-C1 and 6-C2 and then placing them in 5% neutral salt fog per ASTM B-117 as had been done in previous examples.

TABLE Ex. 6.B
Condition of Scribed Panels After 5% Salt Fog

| | PROCESS STEPS | | | | | | | Hrs. to | | White |
|---|---|---|---|---|---|---|---|---|---|---|
| Panel | A | B | C | D | E | F | G | Red Rust | Blisters | Corrosion |
| 6-C2 | X | X | | | X | | | 168* | Large, | Moderate* |
| | | | | | | | | | 40%* | |
| 6-C1 | X | X | | | X | X | X | 1000 | Large, | Light |
| | | | | | | | | | 40%* | |
| 6 | X | X | X | X | X | X | X | >1000 | None | Moderate |

*One of two panels showed red rust. Coating blistered on both panels.

With reference to TABLE Ex. 6.B above, coatings on Panels 6-C2 and 6-C1 blistered within the first week in salt fog. (Red rust also appeared on one of the 6-C2 panels.) In contrast, there were no blisters nor red rust of Panel 6 of the present invention through 1500 hrs. in salt fog. There was observed, however, somewhat more white sacrificial corrosion on Panel 6.

### Example 7

In another embodiment of the present invention, a multi-layered coating system was formed on carbon steel (CS) panels in a manner that was identical to that described in Example 6 except that only a single coat of aluminum-silicate slurry was used in Step (A).

A small CS panel and two large CS panels were coated in an embodiment of this invention in which the panels were prepared exactly as the carbon steel panels were prepared in Example 6 and were coated per Steps (A) through (G) as in that example except that only one coat of basecoat was applied to these panels which will be referred to hereinafter as “Panel 7” panels regardless of size.

### Comparative Example Panel 7-C1

One small CS panel and two large CS panels were cleaned and grit-blasted as was used in the coating of the Panel 7 panel except that Steps (C) and (D) were omitted. The comparative examples are referred to hereafter as “Panel 7-C1”. The steps used in the formation of the multi-ply coatings on Panels 7-C1 and Panel 7 panel and also on the Panel 6 panel of Example 6 are shown in TABLE Ex. 7 below.

TABLE Ex. 7
Coating Process for Panels of Example 7

| STEP | DESCRIPTION | Panel 6 | Panel 7 | 7-C1 |
|---|---|---|---|---|
| A2 | Apply Al-Li/K-silicate slurry | X | X | X |
| B1 | Bake Al-silicate | X | X | X |
| | (30 min. @ 650° F./343° C.) | | | |
| A2 | Apply Al-Li/K-silicate slurry | X | | |
| B1 | Bake Al-silicate | X | | |
| | (30 min. @ 650° F./343° C.) | | | |
| C1 | Apply Solution S1′ | X | X | |
| | (with no solvent) | | | |
| D1 | Bake Treated Al-Silicate | X | X | |
| | (650° F./343° C.) | | | |
| E1 | Burnish Until <5 Ohms | X | X | X |
| F1 | Apply Topcoat T1 (<1 ppm Cr⁺⁶) | X | X | X |
| G1 | Bake Composite | X | X | X |
| | (30 min. @ 650° F./343° C.) | | | |

As in prior examples, stability of the multi-ply coatings on Panels 7 and 7-C1 were compared in the hot deionized (DI) water test described in Example 1.

Accordingly, Panels 7 and 7-C1 were partially immersed in hot DI water at 80° C. (176° F.) for 100 hr. After that exposure, the multi-ply coating on Panel 7-C1 had blistered. By comparison, the multi-ply coating on Panel 7, which is an embodiment of the present invention, had not blistered. The conditions of Panels 7 and 7-C1 after 100 hrs. partially immersed in hot DI water at 80° C. (176° F.) are summarized in TABLE Ex. 7 below.

TABLE Ex. 7.A
Condition After 100 Hrs. in Hot DI Water

| | | | | | | | | Blister Size, | | | |
|---|---|---|---|---|---|---|---|---|---|---|---|
| | | | | | | | | % of Area | | | |
| | | | | | | | | Be- | A- | White | Water |
| Pan- | PROCESS STEPS | | | | | | | low | bove | Bloom- | Clar- |
| el | A | B | C | D | E | F | G | H₂O | H₂O | ing | ity |
| 7- | X | X | | | X | X | X | Fine, | Med., | None | 9 |
| C1 | | | | | | | | <5% | 100% | | (clear) |
| 7 | X | X | X | X | X | X | X | None | None | None | 9 |
| | | | | | | | | | | | (clear) |

It is noted that the Panel 7 panel remained unchanged through 1000 hrs. in hot DI water at which time testing was terminated.

In addition, the corrosion-resistance of the aforementioned coatings system were compared in a 5% salt fog test per ASTM B-117. In this test, an “X” was scribed through the multi-ply coating on one side of each of the large Panel 7 and Panel 7-C1 panels. The scribed panels were placed in a 5% salt fog cabinet operating per ASTM B-117 for 1000 hr. Conditions of the panels are recorded in the TABLE EX. 7.B.

TABLE Ex. 7.B
Condition of Scribed Panels After 5% Salt Fog

| | PROCESS STEPS | | | | | | | Hrs. to | | White |
|---|---|---|---|---|---|---|---|---|---|---|
| Panel | A | B | C | D | E | F | G | Red Rust | Blisters | Corrosion |
| 7-C1 | X | X | | | X | X | X | 1000 | Large, | Light |
| | | | | | | | | | 40%* | |
| 7 | X | X | X | X | X | X | X | >1000 | None | Moderate |

With reference to the above Table, the multi-ply coating on Panels 7-C1 blistered within the first week in salt fog whereas the multi-ply coating of the present invention on Panel 7 remained tightly bonded on those panels throughout exposure.

There was more sacrificial white corrosion on this embodiment of the invention on Panel 7 after 500 hours in salt fog than on Panel 7-C1. However, after 1000 hrs., the blistered comparative coating on Panels 7-C1 showed significant white corrosion and hints of red rust whereas neither rust nor blisters were observed on the Panel 7 coating of this invention.

### Example 8

In another embodiment of the present invention, a multi-layered coating system was formed on carbon steel (CS) panels in a manner that was identical to that described in Example 1 except that a different aluminum-silicate basecoat slurry (“BC3”) was used in Step (A). Whereas the basecoat applied in Example 1 incorporated finely divided aluminum in a sodium-/lithium-silicate binder, the basecoat used in this example contained aluminum powder in a potassium-silicate binder.

One small CS panel and two large CS panels were coated in the preparation of an embodiment of this invention. The panels are referred to hereinafter as “Panel 8” regardless of size; the three panels were prepared exactly as the carbon steel panels of Example 1 and were coated per Steps (A) through (G) as in Example 1 except that, in this example, the aluminum-silicate basecoat utilized a binder of potassium-silicate instead of the one made with sodium- and lithium-silicate used in Example 1. The basecoat used in this example comprised the following binder:

| Al-Silicate Basecoat Slurry, BC3 | Wt. % |
|---|---|
| a) Aluminum Powder | 31.1% |
| (Eckart ™ 407 grade air atomized aluminum powder) | |
| Average particle size: 5 microns | |
| b) Aqueous Potassium Silicate (29.1 % silicate by weight) | 44.4% |
| (K₂O:SiO₂ ratio-2.50; PQ Corp. KASIL ™ 1) | |
| c) Water | 24.5% |
| Ratio of Silicate to aluminum by weight: 0.203 to 1.0 | |

The above ingredients were mixed at high speed using a Conn™ blade.

This aluminum-silicate slurry was applied to the panels using a spray gun as described in Step (A) of Example 1. The potassium-silicate basecoat was dried and cured per Step (B) as described in Ex. 1. Cured panels were treated with Al⁺³PO₄ Solution S1′ as in Step (C) of Example 5, then cured at 650° F. (343° C.) as in Step (D) of Example 5. After being burnished to <5 ohm electrical resistance as in Step (E) of Ex. 1, each panel was overcoated with Al⁺³PO₄ topcoat solution T1 as in Step (F) of that example before being cured per Step (G) of the example.

### Comparative Example Panel 8-C1

One small CS panel and two large CS panels were cleaned, grit-blasted, and coated with the same materials applied to the panel of Panel 8 above in like manner except that Steps (C) and (D) were omitted. These comparative examples are referred to hereafter as Panel 8-C1 regardless of size.

### Comparative Example Panel 8-C2

One small CS panel was cleaned, prepped, and coated with basecoat BC3 as described for the panels of Panels 8 and 8-C1. After curing, the basecoat was burnished with 240-grit abrasive in the same manner as used in Step (E) of Example 1.

After Step (E), electrical resistance of the burnished aluminum-ceramic surface on Panel 8-C2 measured less than 0.5 ohm (electrically conductive) between two probes of an ohmmeter placed one-inch (25 cm) apart on the burnished surface.

### Comparative Example Panel 8-C3

Another small CS panel was cleaned, prepped, and coated with the basecoat BC3 and then cured at 650° F. (343° C.) as in Step (B) of Example 1.

TABLE Ex. 8 below identifies the steps used in preparing the aforementioned panels.

TABLE Ex. 8
Coating Process for Panels of Example 8

| STEP | DESCRIPTION | Panel 8 | 8-C1 | 8-C2 | 8-C3 |
|---|---|---|---|---|---|
| A3 | Apply Al-Kasil silicate slurry and dry | X | X | X | X |
| B1 | Bake Al-silicate | X | X | X | X |
| | (30 min. @ 650° F./343° C.) | | | | |
| A3 | Apply Al-Kasil silicate slurry and dry | X | | X | X |
| B1 | Bake Al-silicate | X | X | X | X |
| | (30 min. @ 650° F./343° C.) | | | | |
| C1 | Apply Solution S1′ (with no solvent) | X | X | X | |
| D1 | Bake Treated Al-Silicate | X | | | |
| | (650° F./343° C.) | | | | |
| E1 | Burnish Until <5 Ohms | X | X | X | |
| F1 | Apply Topcoat T1 (<1 ppm Cr⁺⁶) | X | X | | |
| G1 | Bake Composite | X | X | | |
| | (30 min. @ 650° F./343° C.) | | | | |

Stability of each of the four panels was evaluated in the hot deionized (DI) water test described in Example 1. The results of the evaluation are reported in TABLE Ex. 8.A below.

TABLE Ex. 8.A
Condition After 100 Hrs. in Hot Water

| | | | | | | | | Blister Size, | | | |
|---|---|---|---|---|---|---|---|---|---|---|---|
| | | | | | | | | % of Area | | | |
| | PROCESS STEPS | | | | | | | Below | Above | White | |
| Panel | A | B | C | D | E | F | G | H₂O | H₂O | Blooming | Water Clarity |
| 8-C3 | X | X | | | | | | None, but | None, but | None | 9 (clear) |
| | | | | | | | | coating | coating | | |
| | | | | | | | | dissolved | dissolved | | |
| 8-C2 | X | X | | | X | | | Fine, 90%, | Large, 100% | None | 9 (clear) |
| | | | | | | | | dissolved | dissolved | | |
| 8-C1 | X | X | | | X | X | X | Fine, 90%, | Large, 100% | None | 8 (clear, tint) |
| | | | | | | | | dissolved | dissolved | | |
| 8 | X | X | X | X | X | X | X | None | None | None | 9 (clear) |

With reference to the 100 hr. exposure in hot DI water summarized in the Table above, the potassium-silicate bonding solution had leached from the BC3 basecoat coatings on Panels 8-C2 and 8-C3. When those panels dried, the basecoat simply wiped off the steel as loose powder.

The Panel 8 panel of the present invention remained stable in hot DI water throughout 100 hrs. The coating did not blister or dissolve. After being inspected at 100 hrs., the Panel 8 panel was returned to the hot water. When the test was terminated after 1000 hrs., the coating on of Panel 8 was still unchanged and was tightly bonded to the substrate.

The corrosion-resistant properties of Panels 8, 8-C1, and 8-C2 were compared by scribing those panels and exposing them in 5% neutral salt fog per ASTM B-117. An “X” was scribed through the coating on one side of Panels 8, 8-C1 and 8-C2 and the scribed panels were placed in a 5% neutral salt fog cabinet operating per ASTM B-117 for 1000 hrs. The conditions of the panels are summarized in TABLE Ex. 8.B below.

TABLE Ex. 8.B
Condition of Scribed Panels After 5% Salt Fog

| | PROCESS STEPS | | | | | | | Hrs. to | | White |
|---|---|---|---|---|---|---|---|---|---|---|
| Panel | A | B | C | D | E | F | G | Red Rust | Blisters | Corrosion |
| 8-C2 | X | X | | | X | | | <140 | None | Light |
| 8-C1 | X | X | | | X | X | X | <140 | Large, | Light |
| | | | | | | | | | 40%* | |
| 8 | X | X | X | X | X | X | X | 500 | None | Moderate |

With reference to the above Table, red rust appeared on Panels 8-C2 and 8-C1 before even a week had passed in salt fog. Rust covered so much of the surface of the two 8-C2 panels that they were removed from the test cabinet after week (168 hrs.). Rust was limited to scribe lines on Panel 8-C1 through 500 hr. in salt fog, but spread everywhere by 1000 hrs.

There was no red rust on Panel 8 of the present invention until after 500 hrs. in salt fog and little after even 1000 hrs.

### Example 9

This example describes an embodiment of the present invention that is identical to that of Example 1 except that a silicone resin was added to the Al⁺³PO₄ topcoat solution T1 of Example 1 to create a new topcoat solution for use in Step (F) of this example.

Two coats of the aluminum-silicate basecoat slurry used in Example 1 were applied to grit-blasted carbon steel (CS) panels in the wet-on-wet manner described in Example 4. One small CS panel and two large CS panels coated with the embodiment of this invention in this example are referred to as “Panel 9” hereafter regardless of size.

The cured aluminum-silicate basecoat was treated with Al⁺³PO₄ Solution S1′ in accordance with Steps (C) and (D) of Ex. 6. The treated and cured aluminum-silicate basecoat was lightly blasted as in Step (E) of Ex. 1 until its electrical resistance measured <5 ohms between two probes placed at least 1-inch (25.4 mm) apart on the surface.

An aqueous solution of a silicone resin, Solution R1, was mixed as follows.

| Resin Solution R1 | Wt. % |
|---|---|
| Water-borne silicone resin | 91.5% |
| (Wacher Silrez MP50E) | |
| water | 8.5% |

A silicone-modified, khaki-colored topcoat, Solution T3, was then mixed as follows.

| Topcoat Solution T3 | Vol. % |
|---|---|
| Resin solution R1 | 50% |
| Al⁺³PO₄ Topcoat Solution T1 | 50% |
| (from Example 1) | |

In Step (F) of this example, Solution T3 was sprayed onto Panel 9 as had been done in Step (F) of Example 1. Panel 9 was then dried at 175° F. (79° C.) for at least 15 minutes before being heated to 650° F. (343° C.) and held for 30 minutes to cure the topcoat in Step (G) to complete this embodiment of the invention. The finished, top coated surface was not electrically conductive. It was observed that water beaded readily on the surface.

### Comparative Example for Hot Water Test, Panel 9-C1

One small CS panel and two large CS panels were cleaned, grit-blasted, and coated with the same materials in the same manner as used for Panel 9, except that Steps (C) and (D) were omitted. These comparative examples are referred to hereafter as “Panel 9-C1”, regardless of size.

TABLE Ex. 9 below identifies and summarizes process steps used in preparing Panel 9 that is an embodiment of the present invention and that of the comparative multi-ply example (“Panel 9-C1”).

TABLE Ex. 9
Process Steps for Panels for Ex. 9

| | | | Panel |
|---|---|---|---|
| STEP | DESCRIPTION | Panel 9 | 9-C1 |
| A1 | Apply Al-silicate slurry and air dry | X | X |
| A1 | Apply Al-silicate slurry and air dry | X | X |
| B1 | Bake Al-silicate (30 min. @ 650° F./343° C.) | X | X |
| C1 | Apply Solution S1′ (with no solvent) | X | |
| D1 | Bake Treated Al-Silicate (650° F./343° C.) | X | |
| E1 | Burnish Until <5 ohms | X | X |
| F3 | Apply Topcoat T3 (<1 ppm Cr⁺⁶) | X | X |
| G1 | Bake Composite (30 min. @ 650° F./343° C.) | X | X |

With reference to Table 9, a difference between Panels 9-C1 and Panels 9 became apparent even before preparation of the panels was completed. Soon after a smooth, glossy, wet coat of the topcoat, Solution T3, had been applied to Panel 9-C1, bubbles began to form in the wet topcoat. Some of these bubbles “inflated” to more than 1 mm in diameter. The bubbles eventually burst during heat cure leaving craters in the topcoat film.

Solution T3 did not bubble when applied to the treated and burnished basecoat on Panel 9.

Finished surfaces were not electrically conductive even when probes were placed in craters left in the topcoat where bubbles had broken on Panel 9-C1.

The small CS panels, Panel 9 and 9-C1, were subjected to the hot water stability test described in Example 1. After 100 hrs. sealed in a beaker partially filled with DI water at 80° C. (176° F.), broad blisters had formed above and below the waterline on Panel 9-C1. Coating was separating from the substrate in areas. Table 9.A below summarizes the results of the evaluation.

TABLE Ex. 9.A
Condition After 100 Hrs. in Hot Water

| | Blister Size, % of Area | | White | Water |
|---|---|---|---|---|
| Panel | Below H₂O | Above H₂O | Blooming | Clarity |
| 9-C1 | Large, 90%, | Large, 90% | None | 9.5 (clear) |
| | Some peeling | | | |
| 9 | None | None | None | 9.5 (clear) |

The coating on Panel 9 was unchanged after 100 hrs. partially immersed and sealed in hot DI water. No material had leached from the surface. No chalky white deposits were seen on the panel or in the water in the beaker. The coating on one side of Panel 9 was cut through so the steel substrate was exposed and then returned to the hot water test. At the end of another 100 hr. there was no change in the condition of the coating apart from red rust in the scribe. The coating system remained tightly bonded along the scribe.

The corrosion-resistance of each of the panels was evaluated also. An “X” was scribed through the coating layer on one side of the large CS panels, Panels 9 and 9-C1, so that the substrate was exposed in the scratch. The scribed panels were placed in a 5% neutral salt fog cabinet per ASTM B-117. The results of the evaluation are reported in Table 9.B below.

TABLE Ex. 9.B
Condition of Scribed Panels After 5% Salt Fog

| | | White Corrosion |
|---|---|---|
| Panel | Hrs. to Red Rust | at 1000 hr. |
| 9-C1 | 500 (removed | Heavy |
| | at 1000 hr. due | |
| | to heavy rust) | |
| 9 | 1500 | Light (mostly in scribe) |

The coating system on Panels 9-C1 was almost entirely consumed after 1000 hours in salt fog. Heavy white corrosion due to sacrificial corrosion of aluminum in the basecoat was mixed with significant red rust of the steel substrate.

In contrast, there was no red rust and little white corrosion on Panels 9 through 2000 hours in salt fog.

1. A process for forming on a corrodible substrate a corrosion-resistant multi-ply coating comprising:
applying an aluminum-containing silicate slurry onto the surface of the substrate and heating the deposited slurry to form a cured composite of an aluminum-containing silicate basecoat that is not electrically conductive, optionally repeating the aforementioned step to form a thicker multi-ply coating;
applying an initial solution of trivalent aluminum and phosphate ions (Al⁺³PO₄) to the surface of said basecoat and heating the substrate that has thereon said solution to form a cured ply comprising a composite that is not electrically conductive;
mechanically working the surface of the composite to form a modified composite which is in electrically conductive form; and
applying to the surface of the modified composite an additional solution of trivalent aluminum and phosphate ions (Al⁺³PO₄), the composition of which may be the same as or different from said initial solution; and heating the modified conductive coated surface having thereon said additional solution under conditions which cure it to form said multi-ply coating which is not electrically conductive.

2. A multi-ply coating prepared by the process of claim 1.

3. An article that is coated with the multi-ply coating of claim 2.

4. A process for forming on a corrodible substrate a corrosion-resistant multi-ply coating comprising applying to an aluminum silicate surface which is not electrically conductive and which is hereafter referred to as a basecoat:
(A) an initial solution of trivalent aluminum and phosphate ions (Al⁺³PO₄) and heating said surface that has thereon said solution under conditions which form a cured ply (hereafter “composite”) which is not electrically conductive;
(B) mechanically working the surface of the composite to form a modified composite which is in electrically conductive form; and
(C) applying to the surface of the modified composite an additional solution of trivalent aluminum and phosphate ions (Al⁺³PO₄), the composition of which may be the same as or different from said initial solution; and
(D) heating the modified conductive coated surface having thereon said additional solution under conditions which cure it to form said coating which is not electrically conductive.

5. A multi-ply coating prepared by the process of claim 4.

6. An article that is coated with the multi-ply coating of claim 5.

7. A process for preparing a corrosion-resistant coating composition comprising adding trivalent chromium and nitrate ions to a phosphate solution containing aluminum ions.

8. An article that is coated with the composition of claim 7.

9. A process according to claim 1 wherein one or both of said initial solution and said additional solution contain trivalent chromium and nitrate.

10. A process according to claim 9 wherein said initial solution contains trivalent chromium and nitrate.

11. A process according to claim 9 wherein said additional solution contains trivalent chromium and nitrate.

12. A process according to claim 9 wherein both of said solutions contain chromium and nitrate.

13. A process according to claim 1 wherein said silicate slurry comprises sodium silicate and lithium silicate.

14. A process according to claim 13 wherein said slurry includes also polysilicate.

15. A multi-ply coating prepared by the process of claim 13 or claim 14.

16. An article that is coated with the multi-ply coating of claim 15.

17. A process according to claim 1 wherein said initial solution includes also Mg ion and has a pH of greater than 1.5.

18. A process according to claim 17 wherein said pH is greater than 2.5.

19. A process according to claim 9 wherein said initial solution or said additional solution contains a polymeric resin.

20. A process according to claim 19 wherein said resin is polytetrafluoroethylene or silicones in water.
